(19) United States
(12) Patent Application Publication
(10) Pub. No.: US 2023/0207181 A1
(43) Pub. Date: Jun. 29, 2023

(54) HYBRID TRANSFORMER CORE AND METHOD OF MANUFACTURING A TRANSFORMER CORE

(71) Applicant: Hitachi Energy Switzerland AG, Baden (CH)

(72) Inventors: Marcel Ciesielski, Lodz (PL); Pawel Klys, Lodz (PL); Lukasz Michalski, Lodz, Lodzkie (PL); Grzegorz Kmita, Giebultow (PL)

(21) Appl. No.: 17/928,289

(22) PCT Filed: May 26, 2021
(86) PCT No.: PCT/EP2021/064091

§ 371 Date: Nov. 29, 2022

(30) Foreign Application Priority Data
May 29, 2020 (EP) 20177606.9

(51) Int. Cl. H01F 27/26; H01F 41/02; H01F 3/10; H01F 3/02

(52) U.S. Cl. CPC H01F 27/263; H01F 3/02; H01F 3/10; H01F 41/0233; H01F 2003/106

(57) ABSTRACT

A hybrid transformer core flGf includes comprises columns (21 23) of grain-oriented steel and yokes . A yoke includes a plurality of second plies including sheets of amorphous steel adhered to each other by an adhesive coating on an outer peripheral area of major faces of the sheets of amorphous steel.

### CROSS REFERENCE TO RELATED APPLICATIONS

This application is a 35 U.S.C. § 371 national stage application of PCT International Application No. PCT/EP2021/064091 filed on May 26, 2021, which in turn claims foreign priority to European Patent Application No. 20177616.9, filed on May 29, 2020, the disclosures and content of which are incorporated by reference herein in their entirety.

### FIELD

The disclosure relates to transformer cores and methods of manufacturing transformer cores. The disclosure relates in particular to transformer cores that comprise both grain-oriented steel and amorphous steel.

### BACKGROUND

Power transformers are used for power distribution and power transmission. Shunt reactors and power transformers contribute significantly to losses incurred during power transmission and distribution. It is desirable to provide power transformers that reduce power losses.

Amorphous steel laminations may be formed by cutting a ribbon of amorphous steel into sheets, and forming a stack of sheets that acts as a ply of amorphous steel. During transformer core assembly, the plies of amorphous steel and plies of grain-oriented steel may be stacked. The cutting of the ribbon of amorphous steel may create undesired ripples in the sheets. This problem is exacerbated when a ply of amorphous steel is formed by combining several sheets of amorphous steel in a stack. For illustration, significant variations in thickness may result between the locations at which the ribbon of amorphous steel has been cut and locations that are spaced from the locations at which the ribbon of amorphous steel has been cut. This makes it more difficult to control the geometry, which is particularly critical in joining areas in which the plies of grain-oriented steel and the plies of amorphous steel are lapped.

Another issue with controlling the geometry during core assembly is that the plies of amorphous steel may have a mechanical stiffness that is so low that it can give rise to a bending deformation (also referred to as collapsing) of yokes during core assembly. While additional insulation pads can be used to enable core clamping, it is desirable to reduce the mechanical collapse in the yokes during core assembly.

### SUMMARY

There is a need to provide improved transformer cores and methods of manufacturing transformer cores. There is in particular a need for transformer cores and methods of manufacturing transformer cores in which losses during operation can be reduced by employing a hybrid core construction, while affording improved control over the geometry during transformer core assembly. There is in particular a need for such transformer cores and methods that provide improved stiffness and reduce the risk of collapsing of yokes during transformer core assembly.

According to embodiments of the disclosure, a transformer core and manufacturing method as recited in the independent claims are provided. The dependent claims define embodiments.

A hybrid transformer core comprises columns and yokes. Each column comprises a plurality of first plies of grain-oriented steel. One or more yokes comprise a plurality of second plies. Each second ply comprises a set of sheets of amorphous steel that may be adhered to each other by an adhesive coating on an outer peripheral area of major faces of the sheets of amorphous steel that face another sheet of amorphous steel in the second ply.

The major faces may comprise a central area surrounded by the outer peripheral area. The central area may be free of the adhesive coating.

The outer peripheral area may extend entirely around the central area so as to enclose the central area.

All of the outer peripheral area may be covered by the adhesive coating.

Each second ply may be adhered to a first ply in a layer of the stack forming the yokes and columns.

The outer peripheral area may comprise four segments extending along four sides of the major face and each has an average width, measured perpendicularly to a line along which the side extends and averaged along the extension of the side.

The average width or a maximum width (measured perpendicularly to a line along which the side extends) of the adhesive-coated segment along the side may be 20 mm or less, 15 mm or less, or 10 mm or less.

The major face of each sheet of amorphous steel may have a sheet length and a sheet width that is smaller than the length.

The major face may be rectangular.

The major face may be mitered at its ends in a 45° cut.

A ratio of the maximum width of the segments of the adhesive-coated outer peripheral area that extend along the length direction to the sheet width may be less than 0.15, less than 0.1, or less than 0.07.

A ratio of the average width or of a maximum width of the segments of the adhesive-coated outer peripheral area that extend along the width direction to the sheet length may be less than 0.15, less than 0.1, or less than 0.07.

The adhesive coating may be heat resistant up to at least 300° C., up to at least 310° C., up to at least 320° C., up to at least 330° C., up to at least 340° C., up to at least 400° C., or more.

The adhesive coating may be heat resistant up to an annealing temperature to which the first and second plies are subjected after stacking.

The adhesive coating may be a silicon-resin based coating or another type of heat-resistant adhesive.

The adhesive coating may be an oven-paint.

The hybrid transformer core may further comprise electrically insulating material between adjacent second plies.

The electrically insulating material may comprise an electrically insulating adhesive.

The electrically insulating material may comprise an electrically insulating powder.

The electrically insulating material may be arranged selectively only where the second plies are not lapped with the first plies, i.e., in parts of the yokes that are distinct from joining areas.

The electrically insulating material may be coated or sprayed onto outer surfaces of the second plies.

The electrically insulating material may be arranged such that no electrically insulating material is provided between adjacent sheets of amorphous steel within the second ply (i.e., within a set of sheets adhesively bonded together to form the second ply).

The first plies and the second plies may be stacked in a butt-lap arrangement.

The first plies and the second plies may be stacked in a mixed step-lap/butt-lap arrangement.

The first plies and the second plies may be stacked in a single step lap arrangement, a multi-step lap arrangement, a mitered lap arrangement, a mixed mitered/butt-lap arrangement or another type of transformer core stacking technique.

In a joining area, first and second plies may be alternatingly arranged.

The second plies may extend continuously between different joining areas.

Each second ply may have the same number of sheets of amorphous steel.

Each sheet of amorphous steel may have a thickness that is less than a first thickness of each first ply.

The number of sheets of amorphous steel in each second ply may be selected such that the second ply has a second thickness, the second thickness being the same as the first thickness to within 20%, to within 15%, or within 10%.

Each yoke may comprise at least 1000, at least 2000, at least 3000, at least 4000, at least 5000, at least 6000, at least 7000 second plies or more.

Each column may comprise at least 1000, at least 2000, at least 3000, at least 4000, at least 5000, at least 6000, at least 7000 first plies or more.

A hybrid transformer core according to another aspect of the disclosure comprises columns and yokes. Each column comprises a plurality of first plies of grain-oriented steel. Each yoke comprises a plurality of second plies. Each second ply comprises a set of sheets of amorphous steel. The hybrid transformer core may further comprise electrically insulating material between adjacent second plies.

The electrically insulating material may comprise an electrically insulating adhesive.

The electrically insulating material may comprise an electrically insulating powder.

The electrically insulating material may be arranged selectively only where the second plies are not lapped with the first plies, i.e., in parts of the yokes that are distinct from joining areas.

The electrically insulating material may be coated or sprayed onto outer surfaces of the second plies.

The electrically insulating material may be arranged such that no electrically insulating material is provided between adjacent sheets of amorphous steel within the second ply (i.e., within a set of sheets adhesively bonded together to form the second ply).

A transformer according to the disclosure may comprise the hybrid transformer core according to an embodiment and a plurality of windings.

The transformer may be a distribution transformer.

The transformer may be a single phase distribution transformer.

The transformer may have a rating of up to 315 kVA.

The transformer may have a rating of 315 kVA or more.

The transformer may have a rating of 315 kVA or more and 2499 kVA or less.

The transformer may have a rating of 2499 kVA or more.

The transformer may be a small power transformer.

A method of manufacturing a transformer core may comprise providing a plurality of first plies of grain-oriented steel. The method may comprise forming a plurality of second plies. Forming a second ply may comprise arranging several sheets of amorphous steel on top of each other and applying an adhesive coating to form the second ply in which the adhesive coating is on an outer peripheral area of major faces of the sheets of amorphous steel that face another sheet of amorphous steel in the second ply. The method comprises assembling the transformer core from the plurality of first plies and the plurality of second plies, comprising stacking the first plies and the second plies to form columns and yokes of the transformer core.

Each second ply may be formed such that the major faces may comprise a central area surrounded by the outer peripheral area, wherein the central area may be free of the adhesive coating.

Each second ply may be formed such that the outer peripheral area extends entirely around the central area so as to enclose the central area.

Each second ply may be formed such that all of the outer peripheral area is covered by the adhesive coating.

Each second ply may be formed such that the outer peripheral area comprises four segments extending along four sides of the major face and each having an average width, measured perpendicularly to a line along which the side extends and averaged along the extension direction of the side.

The average width or a maximum width (measured perpendicularly to a line along which the side extends) of the adhesive-coated segment along the side may be 20 mm or less, 15 mm or less, or 10 mm or less.

Each second ply may be formed such that the major face of each sheet of amorphous steel may have a sheet length and a sheet width that is smaller than the length.

Each second ply may be formed such that a ratio of the average or maximum width of the segments of the adhesive-coated outer peripheral area that extend along the length direction to the sheet width may be less than 0.15, less than 0.1, or less than 0.07.

Each second ply may be formed such that a ratio of the average or maximum width of the segments of the adhesive-coated outer peripheral area that extend along the width direction to the sheet length may be less than 0.15, less than 0.1, or less than 0.07.

The method may further comprise an annealing step after stacking the first plies and the second plies.

The method may further comprise cutting the sheets of amorphous steel from a ribbon.

The adhesive coating may be heat resistant up to at least 300° C., up to at least 310° C., up to at least 320° C., up to at least 330° C., up to at least 340° C., up to at least 400° C., or more.

The adhesive coating may be heat resistant up to an annealing temperature used in the annealing step.

The adhesive coating may be a silicon-resin based coating or other types of heat-resistant adhesive.

The adhesive coating may be an oven-paint.

The method may further comprise arranging an electrically insulating material between adjacent second plies in the stacking step.

The electrically insulating material may comprise an electrically insulating adhesive.

The electrically insulating material may comprise an electrically insulating powder.

Arranging the electrically insulating material between adjacent second plies in the stacking step may comprise coating, spraying, or spray-coating the electrically insulating material onto the second ply.

The electrically insulating material may be arranged such that the electrically insulating does not extend between adjacent sheets of amorphous steel within the second ply (i.e., within a set of sheets adhesively bonded together to form the second ply).

Assembling the transformer core may comprise stacking the first plies and the second plies in a butt-lap arrangement.

Assembling the transformer core may comprise stacking the first plies and the second plies in a mixed step-lap/butt-lap arrangement.

Assembling the transformer core may comprise stacking the first plies and the second plies in a single step lap arrangement, a multi-step lap arrangement, a mitered lap arrangement, a mixed mitered/butt-lap arrangement or another type of transformer core stacking technique.

In a joining area, first and second plies may be alternatingly arranged.

The second plies may extend continuously between different joining areas.

Each second ply may be formed to have the same number of sheets of amorphous steel.

Each sheet of amorphous steel may have a thickness that is less than a first thickness of each first ply.

The number of sheets of amorphous steel in each second ply may be selected such that the second ply has a second thickness, the second thickness being the same as the first thickness to within 20%, to within 15%, or within 10%.

Assembling the transformer core may comprise stacking at least 1000, at least 2000, at least 3000, at least 4000, at least 5000, at least 6000, at least 7000 second plies or more to form a yoke.

Assembling the transformer core may comprise stacking at least 1000, at least 2000, at least 3000, at least 4000, at least 5000, at least 6000, at least 7000 first plies or more to form a column.

A method of manufacturing a transformer core may comprise providing a plurality of first plies of grain-oriented steel. The method may comprise forming a plurality of second plies. Forming a second ply may comprise arranging several sheets of amorphous steel on top of each other. The method comprises assembling the transformer core from the plurality of first plies and the plurality of second plies, comprising stacking the first plies and the second plies to form columns and yokes of the transformer core. The method may further comprise arranging an electrically insulating material between adjacent second plies in the stacking step.

The electrically insulating material may comprise an electrically insulating adhesive.

The electrically insulating material may comprise an electrically insulating powder.

Arranging the electrically insulating material between adjacent second plies in the stacking step may comprise coating, spraying, or spray-coating the electrically insulating material onto the second ply.

The electrically insulating material may be arranged such that the electrically insulating does not extend between adjacent sheets of amorphous steel within the second ply (i.e., within a set of sheets adhesively bonded together to form the second plie).

A method of manufacturing a transformer according to the disclosure may comprise forming a transformer core using the method according to an embodiment of the disclosure and forming transformer windings.

The method may further comprise arranging the transformer core and transformer windings in an enclosure.

The transformer may be a distribution transformer.

The transformer may be a single phase distribution transformer.

The transformer may have a rating of up to 315 kVA.

The transformer may have a rating of 315 kVA or more.

The transformer may have a rating of 315 kVA or more and 2499 kVA or less.

The transformer may have a rating of 2499 kVA or more.

The transformer may be a small power transformer.

According to another embodiment of the disclosure, there is provided a use of second plies, each comprising a set of sheets of amorphous steel adhered to each other by an adhesive coating on an outer peripheral area of major faces of the sheets of amorphous steel that face another sheet of amorphous steel in the second ply and wherein the major faces comprise a central area surrounded by the outer peripheral area, the central area being free of the adhesive coating, for forming yokes of a hybrid transformer.

The adhesive coating may be a heat-resistant coating capable of withstanding annealing temperatures to which the second plies are subjected when assembled with plies of grain-oriented steel.

The adhesive coating may be a silicon-based adhesive coating or another type of heat-resistant adhesive.

The use may comprise using the adhesive coating to increase mechanical stability of the second plies during a transformer core assembly step.

The use may comprise using the adhesive coating for controlling a geometry of the second plies during a transformer core assembly step.

The following items are embodiments of the disclosure:

Item 1: A hybrid transformer core, comprising:
columns, each column comprising a plurality of first plies of grain-oriented steel; and
one or more yokes, each of the yokes comprising a plurality of second plies, each second ply comprising sheets of amorphous steel adhered to each other by an adhesive coating on an outer peripheral area of major faces of the sheets of amorphous steel that face another sheet of amorphous steel in the second ply.

Item 2: The hybrid transformer core of item 1, wherein the major faces comprise a central area surrounded by the outer peripheral area, the central area being free of the adhesive coating, optionally wherein the outer peripheral area comprises four segments extending along four sides of the major face and each having an average or maximum width, measured perpendicularly to a line along which the side extends, wherein a ratio of the average or maximum width of the segments of the adhesive-coated outer peripheral area that extend along the length direction to the sheet width is less than 0.15, less than 0.1, or less than 0.07, and/or wherein a ratio of the average or maximum width of the segments of the adhesive-coated outer peripheral area that extend along the width direction to the sheet length is less than 0.15, less than 0.1, or less than 0.07.

Item 3: The hybrid transformer core of any one of the preceding items, wherein the adhesive coating is heat resistant up to at least 300° C., up to at least 310° C., up to at least 320° C., up to at least 330° C., up to at least 340° C., or up to 400° C. or more.

Item 4: The hybrid transformer core of any one of the preceding items, wherein the adhesive coating is a silicon-resin based coating.

Item 5: The hybrid transformer core of any one of the preceding items, further comprising electrically insulating material between adjacent second plies.

Item 6: The hybrid transformer core of item 5, wherein the electrically insulating material comprises an electrically insulating adhesive or an electrically insulating powder.

Item 7: The hybrid transformer core of any one of the preceding items, wherein the first plies and the second plies are stacked in a butt-lap arrangement or a mixed step-lap/butt-lap arrangement.

Item 8: A transformer, comprising the hybrid transformer core of any one of the preceding items and a plurality of windings.

Item 9: The transformer of item 8, wherein the transformer is a distribution transformer.

Item 10: A method of manufacturing a transformer core, comprising:
providing a plurality of first plies of grain-oriented steel;
forming a plurality of second plies, wherein forming a second ply comprises arranging several sheets of amorphous steel on top of each other and applying an adhesive coating to form a second ply in which the adhesive coating is provided on an outer peripheral area of major faces of the sheets of amorphous steel that face another sheet of amorphous steel in the second ply; and
assembling the transformer core from the plurality of first plies and the plurality of second plies, comprising stacking the first plies and the second plies to form columns and one or more yokes of the transformer core.

Item 11: The method of item 10, wherein a central area of the major faces surrounded by the outer peripheral area remains free of the adhesive coating, optionally wherein the outer peripheral area comprises four segments extending along four sides of the major face and each having an average or maximum width, measured perpendicularly to a line along which the side extends, wherein a ratio of the average or maximum width of the segments of the adhesive-coated outer peripheral area that extend along the length direction to the sheet width is less than 0.15, less than 0.1, or less than 0.07, and/or wherein a ratio of the average or maximum width of the segments of the adhesive-coated outer peripheral area that extend along the width direction to the sheet length is less than 0.15, less than 0.1, or less than 0.07.

Item 12: The method of item 10 or item 11, further comprising an annealing step after stacking the first plies and the second plies.

Item 13: The method of any one of items 10 to 12, wherein the adhesive coating is heat resistant up to at least 300° C., up to at least 310° C., up to at least 320° C., up to at least 330° C., up to at least 340° C., up to 400° C. or more; and/or wherein the adhesive coating is a silicon-resin based coating or another type of heat-resistant coating.

Item 14: The method of any one of items 10 to 13, further comprising arranging an electrically insulating material between adj acent second plies in the stacking step, optionally wherein the electrically insulating material comprises an electrically insulating adhesive or an electrically insulating powder.

Item 15: A method of manufacturing a transformer, in particular a distribution transformer, comprising:
forming a transformer core using the method of any one of items 10 to 14;
forming transformer windings; and
arranging the transformer core and transformer windings in an enclosure.

Various effects and advantages are associated with the disclosure. The hybrid cores reduce losses during operation by employing a hybrid core construction, while affording improved control over the geometry and/or mechanical characteristics during transformer core assembly. The adhesive coating reduces the problems associated with ripples in individual sheets of amorphous steel while providing enhanced mechanical stability to each ply assembled from the sheets of amorphous steel and the yokes formed therefrom. By limiting the area to which the adhesive coating is applied to an outer peripheral area of major faces of the sheets of amorphous steel that face another sheet of amorphous steel in the set that forms the second ply, effects of the adhesive coating on geometry can be kept small.

### BRIEF DESCRIPTION OF THE DRAWINGS

The subject-matter of the disclosure will be explained in more detail with reference to exemplary embodiments which are illustrated in the attached drawings, in which:

FIG. 1 is a schematic view of a hybrid transformer core according to an embodiment.

FIG. 2 is a plan view of the hybrid transformer core of FIG. 1.

FIG. 3 is a cross-sectional view through a joining area of the hybrid transformer core.

FIG. 4 is a cross-sectional view through a yoke area of the hybrid transformer core.

FIG. 5 is an exploded view of a second ply of sheets of amorphous steel used in the hybrid transformer core.

FIG. 6 is a plan view of an adhesive-coated sheet of amorphous steel used in the hybrid transformer core.

FIG. 7 is a plan view illustrating an exemplary intermediate state during an assembling step of the hybrid transformer core.

FIG. 8 is a cross-sectional view through a yoke area of the hybrid transformer core.

FIG. 9 is a flow chart of a method according to an embodiment.

FIG. 10 is a plan view of an adhesive-coated sheet of amorphous steel used in the hybrid transformer core in which an adhesive layer has a varying width.

### DETAILED DESCRIPTION OF EMBODIMENTS

Exemplary embodiments of the disclosure will be described with reference to the drawings in which identical or similar reference signs designate identical or similar elements. While some embodiments will be described in the context of a distribution transformer, the embodiments are not limited thereto. The features of embodiments may be combined with each other, unless specifically noted otherwise.

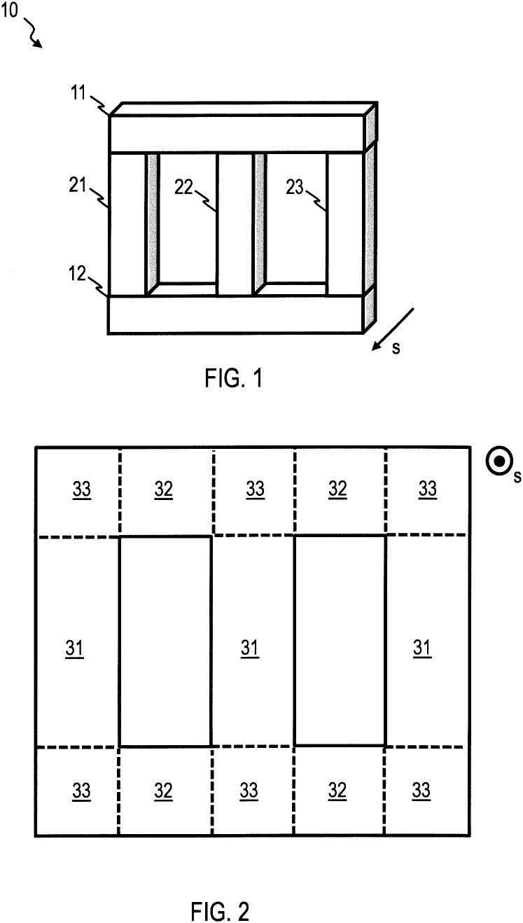

FIG. 1 is a perspective view of a hybrid transformer core 10 according to an embodiment. The hybrid transformer core 10 comprises a first yoke 11 and optionally a second yoke 12. Plies assembled from sheets of amorphous steel adjoined to each other are used to form the first and second yokes 11, 12.

While two yokes 11, 12 made of amorphous steel are shown in FIG. 1, the hybrid transformer core may have one yoke made of amorphous steel.

The hybrid transformer core 10 comprises columns 21-23 (which are also referred to as legs or limbs in the art). Windings are wound around the columns 21-23 of the hybrid transformer core 10. Plies of grain-oriented steel may be used to form the columns 21-23.

Three columns may extend between the yokes 11, 12. In other variants, only two columns may extend between the yokes 11, 12, e.g., in a single-phase core-type transformer. Other configurations are possible.

In general terms, transformers are commonly used to transfer electrical energy from one circuit to another through inductively coupled conductors. The inductively coupled conductors are defined by the windings of the transformer. A varying current in the first or primary winding creates a varying magnetic flux in the transformer’s core and thus a varying magnetic field through the secondary winding. Some transformers, such as transformers for use at power or audio frequencies, typically have cores made of high-permeability silicon steel. The steel has a permeability many times that of free space and the core thus serves to greatly reduce the magnetizing current and confine the flux to a path which closely couples the windings.

The disclosed embodiments relate to hybrid transformer cores, especially such hybrid transformer cores 10 which combine one or several yokes 11, 12 of amorphous steel (it being noted that plies of amorphous steel being lapped with plies of grain-oriented steel in joining areas) and columns 21-23 of grain-oriented steel (it being noted that plies of amorphous steel being lapped with plies of grain-oriented steel in joining areas). Various stacking techniques may be used, such as a butt-lap, a mixed step-lap/butt-lap, a single step lap, a multi-step lap, a mitered lap, a mixed mitered/butt-lap, combinations thereof, or another type of transformer core stacking procedure.

The amorphous steel used in the first yoke 11 and the second yoke 12 may have the same isotropy in all directions, at least in the plane of the amorphous steel sheets.

The first yoke 11 may be regarded as a top yoke and the second yoke 12 may be regarded as a bottom yoke. The first yoke 11 and the second yoke 12 may be formed as beams. The beams may take one of a number of different shapes. The shape may generally be defined by the cross-section of the beams. For illustration, each one of the first yoke 11 and the second yoke 12 may have a rectangular shaped cross-section, without being limited thereto. The columns 21-23 may have a rectangular cross-section, without being limited thereto.

The columns 21-23 are coupled to the first and second yokes 11, 12. As will be described in more detail below, each one of the columns 21-23 may be formed by stacking first plies of grain-oriented steel. The first plies of grain-oriented steel may be stacked on top of each other along a stacking direction s.

Each one of the yokes 11, 12 may be formed by stacking second plies that are generally formed of amorphous steel. The second plies of amorphous steel may be stacked on top of each other along the stacking direction s. Each second ply may be composed of a set of sheets of amorphous steel arranged on top of each other and adhesively bonded to each other using an adhesive coating. As will be explained in more detail below, the adhesive coating may be provided in an outer peripheral area of major faces of those sheets of amorphous steel in a second ply that face another sheet of amorphous steel in the same second ply.

The stack of second plies that is formed during transformer core assembly should not be confused with the set of sheets of amorphous steel that is used to form the second plies that are subsequently used in the transformer core assembly. Each second ply may include less than 25, less than 20, less than 15, or less than 10 sheets of amorphous steel. At least 1000, at least 2000, at least 3000, at least 4000, at least 5000 or even more second plies (each comprising a much smaller number of adhesively bonded sheets of amorphous steel) may be stacked during transformer core assembly.

FIG. 2 is a plan view of the hybrid transformer core 10 of FIG. 1. The stacking direction s is orthogonal to the drawing plane of FIG. 2.

The hybrid transformer core 10 comprises column areas 31 in which first plies of grain-oriented steel are stacked on top of each other along the stacking direction s.

The hybrid transformer core 10 comprises yoke areas 32 in which second plies are stacked on top of each other along the stacking direction s. Each second ply may comprise a set of sheets of amorphous steel that are adhesively bonded together, as will be explained in more detail below.

The hybrid transformer core 10 comprises joining areas 33 in which first plies of grain-oriented steel and second plies of amorphous steel are lapped. The first and second plies may alternate along the stacking direction s in the joining areas 33. It will be appreciated that it is possible to discriminate different second plies in the assembled transformer core. For illustration, in each single layer of the stack, a second ply is adjoined to a first ply. A joining area 33 is formed in which first and second plies overlap. Such a second ply includes plural sheets of amorphous steel, which may be adhesively-bonded in a specific manner, as will be described below.

Other stacking techniques may be used. For illustration, a butt-lap, a mixed step-lap/butt-lap, a single step lap, a multi-step lap, a mitered lap, a mixed mitered/butt-lap, combinations thereof, or another type of transformer core stacking procedure may be employed.

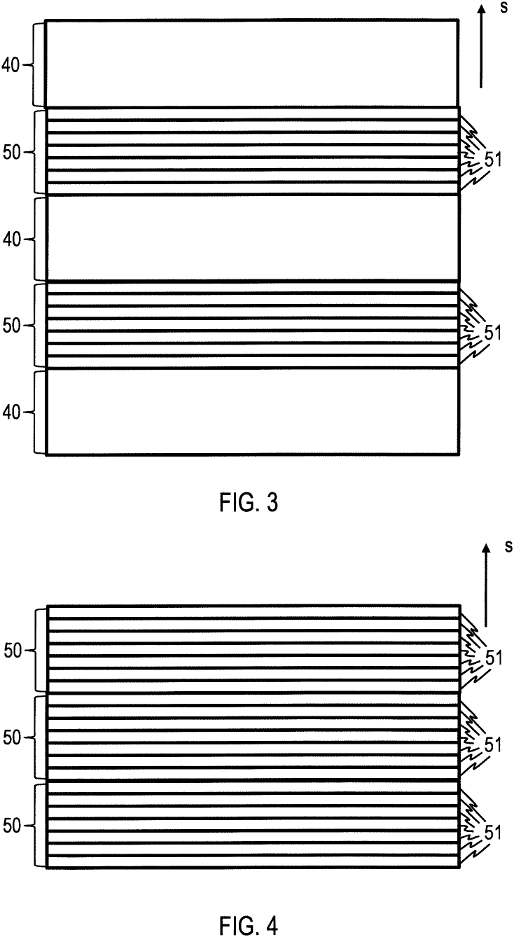

FIG. 3 is a cross-sectional view of the hybrid transformer core 10 in the joining area 33. FIG. 4 is a cross-sectional view of the hybrid transformer core 10 in the yoke area 32. The stacking direction s extends in the drawing plane.

In the joining area 33 (as shown in FIG. 3), first plies 40 of grain-oriented steel and second plies 50 alternate along the stacking direction s. Each second ply 50 comprises plural sheets of amorphous steel 51. The plural sheets of amorphous steel 51 are adhesively bonded to each other. The plural sheets of amorphous steel 51 may be adhesively bonded to each other using a heat resistant adhesive coating, which is capable of at least withstanding annealing temperatures to which the second plies 50 are subjected after the first and second plies have been stacked in the transformer core assembly.

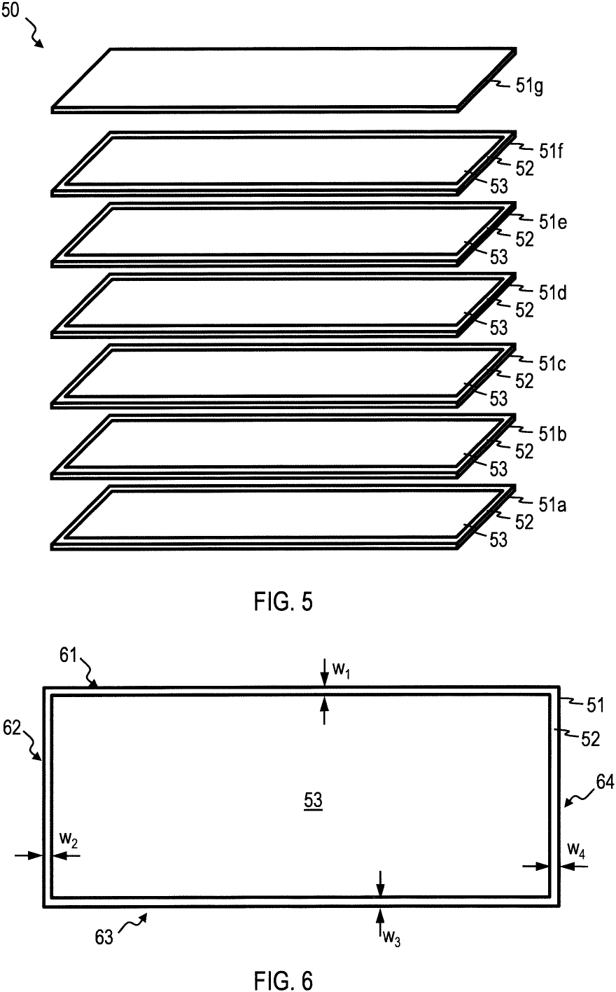

In the yoke area 32 (as shown in FIG. 4), the second plies 50 are stacked on top of each other along the stacking direction s. Each second ply 50 comprises plural sheets of amorphous steel 51. The plural sheets of amorphous steel 51 are adhesively bonded to each other, as will be described in more detail with reference to FIGS. 5 and 6. The adhesive coating that is used to assemble a set of sheets of amorphous steel 51 into a second ply 50 may be provided such that it does not extend between adjacent second plies 50. Electrically insulating material may be arranged between adjacent second plies 50 in the yoke

The number of sheets of amorphous steel 51 in each second ply 50 may be selected depending on a thickness of each individual sheet of amorphous steel 51 and the thickness of the first ply 40. Each first ply 40 may have a first thickness t₁. Each individual sheet of amorphous steel 51 may have a sheet thickness tₛ. The number n of sheets of amorphous steel 51 in each second ply 50 may be selected such that n × tₛ ≅ t₁.

The sheets of amorphous steel 51 in each second ply 50 may be adhesively bonded to each other using an adhesive coating. In the transformer core, the adhesive coating may be provided on an area on the major surfaces of the sheets of amorphous steel 51 that is limited to an outer peripheral area of those major faces that face another one of the sheets of amorphous steel 51 within the same stack. A central area of the major faces that is surrounded by the adhesive-covered outer peripheral area may remain free of the adhesive coating.

After application, liquid adhesive may penetrate an area between the sheets of amorphous steel 51. This depends on the characteristics of the adhesive, such as viscosity. Thus, the adhesive coating may be formed by first stacking the sheets of amorphous steel 51 and then applying the adhesive to the outer edge of the stack, from where it penetrates in between the sheets of amorphous steel 51 in the stack.

FIG. 5 is an exploded view of a set of sheets of amorphous steel 51a-g that are adhesively bonded to each other to form a single second ply 50. Many (e.g., at least 1000, at least 2000, at least 3000, at least 4000, at least 5000, at least 6000, at least 7000 second plies or more) may be formed in this manner and may be stacked in a transformer core assembling step.

While seven sheets of amorphous steel 51a-g are illustrated in FIG. 5, the number of sheets of amorphous steel may be different. For illustration, the number n of sheets of amorphous steel 51 in each second ply 50 may be selected depending on the thickness of each sheet of amorphous steel 51 and the thickness of the first plies 40.

A first sheet of amorphous steel 51a has a major face that faces towards another sheet of amorphous steel 51b in the same second ply. Only an outer peripheral area 52 of this major face of the first sheet of amorphous steel 51a is covered with an adhesive coating that is used to adhesively bond the first sheet of amorphous steel 51a to the second sheet of amorphous steel 51b in the same second ply. A central area 53 of the major face that is enclosed by the outer peripheral area 52 may be free from the adhesive coating.

Similarly, a second sheet of amorphous steel 51b has a major face that faces towards another sheet of amorphous steel 51c in the same third ply. Only an outer peripheral area 52 of this major face of the second sheet of amorphous steel 51b is covered with an adhesive coating that is used to adhesively bond the second sheet of amorphous steel 51b to the third sheet of amorphous steel 51c in the same second ply 50. A central area 53 of the major face that is enclosed by the outer peripheral area 52 may be free from the adhesive coating.

Similarly, the major faces of the sheets of amorphous steel 51c-f seen in FIG. 5 that face towards another sheet of amorphous steel 51d-g may have an adhesive coating that extends over and is limited to an outer peripheral area 52 of the major faces, leaving the central areas 53 of the major faces free from adhesive coating.

The adhesive coating may be heat resistant up to at least 300° C., up to at least 310° C., up to at least 320° C., up to at least 330° C., up to at least 340° C., up to at least 400° C., or more. The adhesive coating may be a silicon-resin based coating. The adhesive coating may be silicon-based paint that adhesively bonds adjacent sheets of the amorphous steel 51a-g to each other, while being capable of withstanding annealing temperatures used in transformer core manufacture. The adhesive coating may be another type of heat-resistant adhesive

FIG. 6 is a plan view of a major face of a sheet of amorphous steel 51. The configuration explained with reference to FIG. 6 may be used for each one of the major faces of the sheets of amorphous steel 51a-f in FIG. 5.

The sheet of amorphous steel 51 has a sheet length and a sheet width, with the sheet length being greater than the sheet width. The sides of the sheet of amorphous steel 51 extending along the sheet length will be referred to as “long sides”, and the sides of the sheet of amorphous steel 51 extending along the sheet width will be referred to as “short sides.”

The outer peripheral area 52 has a first segment 61 extending continuously along a first long side of the sheet of amorphous steel 51. The outer peripheral area 52 has a second segment 62 extending continuously along a first short side of the sheet of amorphous steel 51. The outer peripheral area 52 has a third segment 63 extending continuously along a second long side of the sheet of amorphous steel 51 that is opposite the first long side. The outer peripheral area 52 has a fourth segment 64 extending continuously along a second short side of the sheet of amorphous steel 51 that is opposite the first short side.

The adhesive-covered outer peripheral area 52 has a first width w₁ measured perpendicular to the extension direction of the first long side of the sheet of amorphous steel 51. When the width varies along the extension direction of the first long side of the sheet of amorphous steel 51, the maximum value is referred to as first maximum width w₁. When the width varies along the extension direction of the first long side of the sheet of amorphous steel 51, an average of the width (with averaging being performed along the first long side) is referred to as first average width w₁.

The adhesive-covered outer peripheral area 52 has a second width w₂ measured perpendicular to the extension direction of the first short side of the sheet of amorphous steel 51. When the width varies along the extension direction of the first short side of the sheet of amorphous steel 51, the maximum value is referred to as second maximum width w₂. When the width varies along the extension direction of the first short side of the sheet of amorphous steel 51, an average of the width (with averaging being performed along the first short side) is referred to as second average width w₂.

The adhesive-covered outer peripheral area 52 has a third width w₃ measured perpendicular to the extension direction of the second long side of the sheet of amorphous steel 51. When the width varies along the extension direction of the second long side of the sheet of amorphous steel 51, the maximum value is referred to as third maximum width w₃. When the width varies along the extension direction of the second long side of the sheet of amorphous steel 51, an average of the width (with averaging being performed along the second long side) is referred to as third average width w₃.

The adhesive-covered outer peripheral area 52 has a fourth width w₄ measured perpendicular to the extension direction of the second short side of the sheet of amorphous steel 51. When the width varies along the extension direction of the second short side of the sheet of amorphous steel 51, the maximum value is referred to as fourth maximum width w₄. When the width varies along the extension direction of the second short side of the sheet of amorphous steel 51, an average of the width (with averaging being performed along the second short side) is referred to as fourth average width w₄.

A ratio of the average or maximum width w₁, w₃ of the segments of the adhesive-coated outer peripheral area 52 that extend along the length direction to the sheet width may be less than 0.15, less than 0.1, or less than 0.07.

A ratio of the average or maximum width w₂, w₄ of the segments of the adhesive-coated outer peripheral area that extend along the width direction to the sheet length may be less than 0.15, less than 0.1, or less than 0.07.

A second ply 50 in which sheets of amorphous steel 51a-g are adhesively bonded to each other, while the adhesive coating that affects the adhesive coating is provided in an adhesive-coated outer peripheral area 52 of the major faces the sheets of the amorphous steel 51a-f that face another sheet in the same second ply may be attained by positioning the sheets of amorphous steel 51a-g on top of each other (thereby forming a staple of the sheets 51a-g) and then applying the adhesive coating from along the outer edges. The sheets 51a-g may be mechanically supported, e.g., clamped from the top and bottom, during the application of the adhesive coating. Inward diffusion of the adhesive coating causes the sheets 51a-g to be adhesively bonded by the adhesive coating that extends on the outer peripheral area 52 of the major faces.

While a substantially constant width of the adhesive-coated area is schematically illustrated in FIGS. 5 and 6, the width of the adhesive-coated area may vary. For illustration, the adhesive distribution may be dependent on adhesive consistency, the amount of adhesive used for gluing purpose, the procedure of gluing, and/or the pressing force applied on amorphous stack 50. However, the adhesive may be applied in such a manner that the adhesive is concentrated at or along a peripheral area on the major faces of the sheet of amorphous steel 51.

A fraction of the adhesive may be distributed unevenly, diffusing further towards the center of the sheet of amorphous steel 51. With the adhesive being applied as a liquid, small traces of liquid adhesive may reach even the center regions of the major face of the sheet of amorphous steel 51.

FIG. 10 is an exemplary view showing such an adhesive distribution.

While the adhesive may extend away from the edges, the average width (with the width being measured transverse to the respective sides of the rectangular major face, but averaging being performed along the sides) is still small as compared to the width and/or length of the sheet.

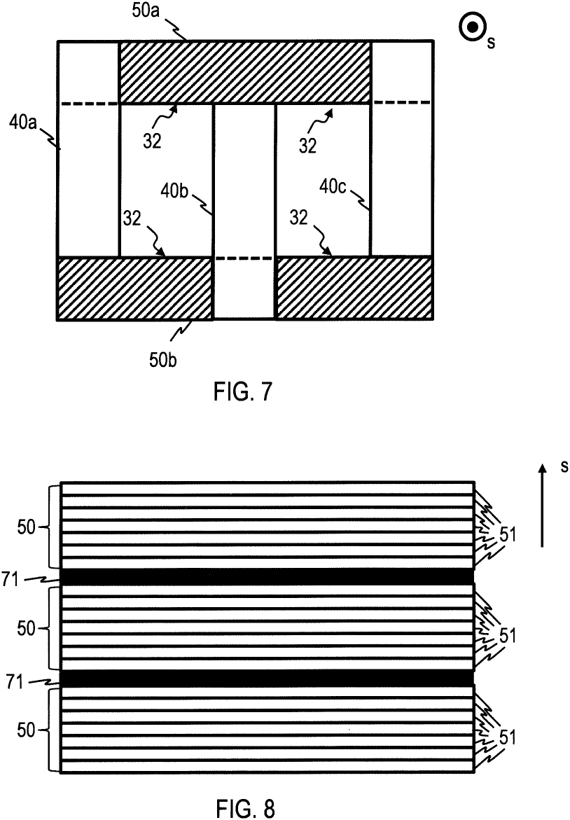

FIG. 7 shows an exemplary intermediate state of stacking the first and second plies 40, 50 in a transformer core assembly process. A second ply 50a that is included in the first yoke 11 is adjoined to a first ply 40a included in the first column 21 and a first ply 40c included in the third column 23. In a joining area, the first ply 40a and the first ply 40c overlap second plies of the underlying layer in the first yoke 11. In a joining area, the second ply 50a overlaps a first ply included in the second column 22 in the underlying layer.

Another second ply 50b that is included in the second yoke 12 is adjoined to the first ply 40a included in the first column 21 and the first ply 40c included in the third column 23. In a joining area, the first ply 40b included in the second column 22 overlaps a second ply included in the second yoke 12 in the underlying layer.

At least in the yoke areas 32 that are adjacent the joining areas, and in which no first plies 40 are present, an electrically insulating material may optionally be arranged between adjacent second plies 50, in order to further reduce losses during operation of the transformer.

FIG. 8 is a cross-sectional view through the transformer core in the yoke areas 32. An electrically insulating material 71 is disposed between adjacent second plies 50. The electrically insulating material 71 may be applied as a layer onto an outer surface of the second plies 50. The electrically insulating material 71 may comprise an electrically insulating paint or an electrically insulating powder. The electrically insulating paint or powder may be applied by coating, spraying, or spray-coating.

While rectangular first and second plies are shown in FIGS. 2 to 8, the first plies and the second plies may be mitered at their ends in a 45° cut.

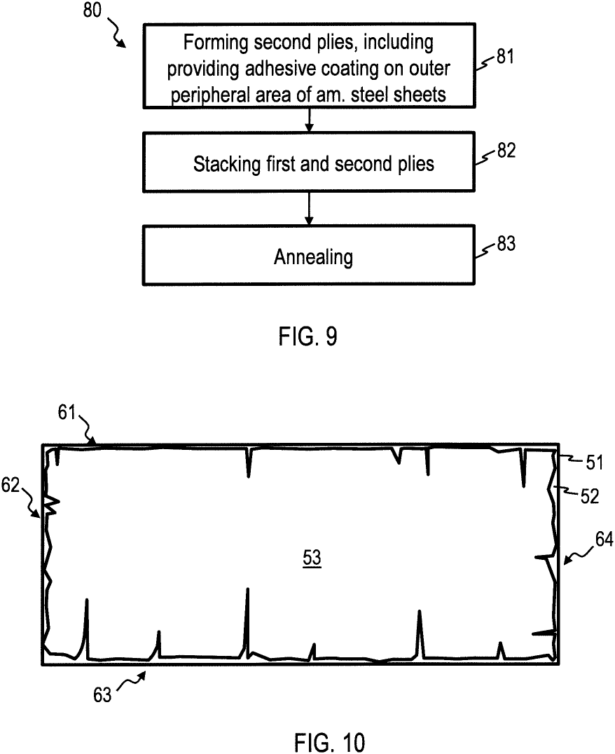

FIG. 9 is a flow chart of a method 80 according to an embodiment.

The method may optionally comprise a step of cutting sheets of amorphous steel from a ribbon of amorphous steel. The sheets may be cut to have the same sheet length and sheet width.

The method comprises a step 81 of forming a plurality of second plies 50 from the sheets of amorphous steel. Each second ply 50 may be formed by arranging several sheets of amorphous steel (e.g., more than five sheets 51) on top of each other and applying an adhesive coating to form the second ply 50 in which the adhesive coating is on an outer peripheral area 52 of major faces of the sheets of amorphous steel that face another sheet of amorphous steel in the same second ply 50.

In step 81, the sheets of amorphous steel 51 in each second ply 50 may be adhesively bonded to each other using an adhesive coating.

For each second ply 50, forming the second ply 50 may comprise positioning the sheets of amorphous steel on top of each other (thereby forming a staple of the sheets) and then applying the adhesive coating from along the outer edges of the staple. The sheets may be mechanically supported, e.g., clamped from the top and bottom, during the application of the adhesive coating at the edges. Inward diffusion of the adhesive coating causes the sheets to be adhesively bonded by the adhesive coating that extends on the outer peripheral area of the major faces.

Forming the second plies may comprise a step of curing the adhesive coating before the first and second plies are stacked in a transformer core assembly step.

The applied adhesive coating may be heat-resistant. The adhesive coating may be such that the set of sheets in the second ply 50 remain adhesively bonded during an annealing step. The adhesive coating may be heat resistant in the sense that it does not liquify, burn and/or char when heated to a temperature that may be 300° C. or more, 310° or more, 320° or more, 330° or more, 340° C. or more, 400° C. or more. The adhesive coating may be heat resistant in the sense that it does not liquify, burn and/or char when heated in the annealing step 83.

The method comprises a transformer core assembly step 82. The transformer core assembly step 82 may comprise stacking the first plies 40 of grain-oriented steel and the second plies 50 that are formed of adhesively-bonded sheets of amorphous steel to form the yokes and columns of the transformer core. The first plies 40 and the second plies 50 may be stacked in a butt-lap arrangement, a mixed step-lap/butt-lap arrangement, a single step lap, a multi-step lap, a mitered lap, a mixed mitered/butt-lap, combinations thereof, or other types of stacking procedure.

The method comprises an annealing step 83. The annealing step 83 is performed after the stacking the first and second plies 40, 50.

The method may comprise additional steps. For illustration, the method can comprise clamping the stacked arrangement of first and second plies 40, 50.

The method may comprise winding the transformer windings around the columns 21-23.

The method may comprise mounting connection elements to the windings.

The method may comprise mounting the hybrid transformer core 10 with the windings in an enclosure, such as a transformer tank. The yokes 11, 12 may be fastened to the enclosure by fastening means. The hybrid transformer core 10 may be fastened to the enclosure by means of fastening means at at least one of the yokes 11, 12. The fastening means may lock against vertical forces applied to the hybrid transformer core 10 during operation. The fastening means may isolate the hybrid transformer core 10 from the enclosure.

The method may comprise installing, testing and/or operating the transformer.

The hybrid transformer core may be provided in a distribution transformer. The distribution transformer may have a rating of up to 315 kVA, of 315 kVA or more, of 315 kVA or more and 2499 kVA or less, or of 2499 kVA or more. The hybrid transformer core may be provided in a single phase distribution transformer. The hybrid transformer core may be provided in a small power transformer.

The use of an adhesive to bond sheets of amorphous steel to plies for hybrid core assembly provides various effects such as mechanical stiffness, enhanced control over the geometry of the stack, possibly additional electrical insulation between amorphous sheets and simplifies the stacking. The adhesive coating is heat resistant so as to withstand the hybrid core annealing treatment that may take place in a temperature in a range of about 340° C. The adhesive coating may be heat resistant up to higher temperatures, e.g., 400° C. or more.

Adhesively bonding sheets of amorphous metal 51 to form second plies 50 in a dedicated step before the first and second plies 40, 50 are assembled provides ease of handling and simplifies the transformer core assembly process.

By implementing the adhesive bonding in such a manner that the adhesive coating is provided in an outer peripheral area of the adhesively bonded sheets of amorphous metal 51 allows the amount of adhesive to be reduced as compared to a technique in which the entire major faces of the sheets of amorphous metal 51 are coated with adhesive. The lower amount of adhesive coating facilitates the control of the geometry.

Adhesively bonding the sheets of amorphous metal 51 in the second plies 50 along the outer peripheral area also provides second plies with power loss characteristics that are comparable to those of surface-coated sheets of amorphous metal. In the following table, loss testing results are summarized as a function of magnetic flux density. The loss is the average over plural samples of several plies that use surface-coating for adhesive bonding and plural samples of several plies that use an adhesive bonding by coating along the outer peripheral area:

| Flux density [T] | ø loss for adhesively bonded plies with surface coating [W/kg] | ø loss for adhesively bonded plies with coating along the outer peripheral area [W/kg] |
|---|---|---|
| 0.6 | 0.062 | 0.060 |
| 0.7 | 0.081 | 0.080 |
| 0.8 | 0.103 | 0.103 |
| 0.9 | 0.128 | 0.129 |
| 1.0 | 0.155 | 0.157 |
| 1.1 | 0.183 | 0.185 |
| 1.2 | 0.213 | 0.215 |
| 1.3 | 0.249 | 0.251 |
| 1.4 | 0.291 | 0.292 |
| 1.5 | 0.350 | 0.349 |

Thus, even when the sheets of amorphous metal are adhesively bonded only in an outer peripheral area, losses remain comparable to sheets that are adhesively bonded by an adhesive coating applied on the entire major faces.

By using a heat resistant adhesive coating for adhesive bonding, which is able to withstand the annealing temperatures, annealing or other heat treatment can be performed after the first and second plies have been stacked in the transformer core assembly process. This is beneficial, because the amorphous steel sheets may be too delicate for annealing prior to stacking in the transformer core assembly process.

The precise adhesive application technology and the preparation of ready to stack amorphous plies 50 is a solution which controls the geometry of the second plies 50 of amorphous steel, thereby prevents high core height differences, increases yoke stiffness and can provide insulation between core layers.

The adhesively bonded samples show specific losses that, when compared to grain-oriented steel, are lower for in the nominal induction target range for yokes in hybrid cores, which ranges from 1.1 -1.4 T. Adhesive coating application for amorphous metal sheets in hybrid cores ensures satisfactory stiffness, controls yoke geometry, can provide insulation and speeds up the core assembly process.

By adhesively bonding sheets of amorphous metal in an outer peripheral area, the plies 50 of amorphous metal are obtained that are ready for stacking in a butt-lap/mixed butt-lap and step-lap hybrid core assembly technology. Various stacking techniques may be employed, such as a butt-lap, a mixed step-lap/butt-lap, a single step lap, a multi-step lap, a mitered lap, a mixed mitered/butt-lap, combinations thereof, or another type of transformer core stacking procedure. Precise edge gluing controls the ply geometry and provides satisfactory stiffness, which is a key factor during proper hybrid core stacking process and clamping.

A thin adhesive or powder surface can be provided between previously edge bonded plies 50 of amorphous steel per every core layer during the hybrid core assembly. This provides electrical insulation between layers and prevents additional losses as a result of circulating currents.

Various effects and advantages are associated with the disclosure. The disclosure provides hybrid transformer cores and methods of manufacturing hybrid transformer cores in which losses during operation can be kept small by employing a hybrid core construction, while affording improved control over the geometry during transformer core assembly. For illustration, yoke stiffness can be enhanced and the risk of collapsing of yokes during transformer core assembly can be reduced.

The methods and systems according to the disclosure may be used in association with distribution transformers or power transformers, without being limited thereto.

While the disclosure has been described in detail in the drawings and foregoing description, such description is to be considered illustrative or exemplary and not restrictive. Variations to the disclosed embodiments can be understood and effected by those skilled in the art and practicing the claimed disclosure, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A hybrid transformer core comprising:
a plurality of columns each column comprising a plurality of first plies of grain-oriented steel; and
one or more yokes each of the yokes comprising a plurality of second plies each second ply comprising sheets of amorphous steel adhered to each other by an adhesive coating on an outer peripheral area of major faces of the sheets of amorphous steel that face another sheet of amorphous steel in the same second ply the major faces comprising a central area surrounded by the outer peripheral area the central area being free of the adhesive coating.

2. The hybrid transformer core of claim 1,
wherein the adhesive-coated outer peripheral area comprises four segments of the adhesive-coated outer peripheral area extending along four sides of the major face and each having an average or maximum width measured perpendicularly to a line along which the side extends, wherein a ratio determined as the average width of the segments of the adhesive-coated outer peripheral area that extend along the length direction divided by the sheet width is less than 0.15, and/or wherein a ratio determined as the average width of the segments of the adhesive-coated outer peripheral area that extend along the width direction divided by the sheet length is less than 0.15.

3. The hybrid transformer core of claim 1 wherein the adhesive coating is heat resistant up to at least 300° C.

4. The hybrid transformer core of claim 1 wherein the adhesive coating is a silicon-resin based coating.

5. The hybrid transformer core of claim 1 further comprising electrically insulating material between adjacent second plies.

6. The hybrid transformer core of claim 5, wherein the electrically insulating material comprises an electrically insulating adhesive or an electrically insulating powder.

7. The hybrid transformer core of claim 1, wherein the first plies and the second plies are stacked in a butt-lap arrangement or a mixed step-lap/butt-lap arrangement.

8. A transformer, comprising:
the a hybrid transformer core comprising:
a plurality of columns, each column comprising a plurality of first plies of grain-oriented steel; and
one or more yokes, each of the yokes comprising a plurality of second plies, each second ply comprising sheets of amorphous steel adhered to each other by an adhesive coating on an outer peripheral area of major faces of the sheets of amorphous steel that face another sheet of amorphous steel in the same second ply, the major faces comprising a central area surrounded by the outer peripheral area, the central area being free of the adhesive coating; and a plurality of windings.

9. The transformer of claim 8, wherein the transformer is a distribution transformer.

10. A method of manufacturing a transformer core comprising:
providing a plurality of first plies of grain-oriented steel;
forming a plurality of second plies comprising arranging several sheets of amorphous steel on top of each other and applying an adhesive coating to form a second ply in which the adhesive coating is provided on an outer peripheral area of major faces of the sheets of amorphous steel that face another sheet of amorphous steel in the same second ply, a central area of the major faces being surrounded by the outer peripheral area remains free of the adhesive coating; and
assembling the transformer core from the plurality of first plies and the plurality of second plies, comprising stacking the first plies and the second plies to form columns and one or more yokes of the transformer core.

11. The method of claim 10,
wherein the adhesive-coated outer peripheral area comprises four segments of the adhesive-coated outer peripheral area extending along four sides of the major face and each having an average or maximum width measured perpendicularly to a line along which the side extends, wherein a ratio determined as the average or maximum width of the segments of the adhesive-coated outer peripheral area that extend along the length direction divided by the sheet width is less than 0.15, and/or wherein a ratio determined as the average or maximum width of the segments of the adhesive-coated outer peripheral area that extend along the width direction divided by the sheet length is less than 0.15.

12. The method of claim 10 further comprising an annealing step after stacking the first plies and the second plies.

13. The method of claim 10 wherein the adhesive coating is a silicon-resin based coating or another type of heat-resistant coating.

14. The method of claim 10 further comprising arranging an electrically insulating material between adjacent second plies in the stacking step, optionally wherein the electrically insulating material comprises an electrically insulating adhesive or an electrically insulating powder.

15. A method of manufacturing a transformer, a comprising:
forming a transformer core using the method of claim 10
forming transformer windings; and
arranging the transformer core and transformer windings in an enclosure.

16. The hybrid transformer core of claim 1,
wherein the adhesive-coated outer peripheral area comprises four segments of the adhesive-coated outer peripheral area extending along four sides of the major face and each having an average or maximum width, measured perpendicularly to a line along which the side extends, wherein a ratio determined as the maximum width of the segments of the adhesive-coated outer peripheral area that extend along the length direction divided by the sheet width is less than 0.15, and/or wherein a ratio determined as the maximum width of the segments of the adhesive-coated outer peripheral area that extend along the width direction divided by the sheet length is less than 0.15.

17. The hybrid transformer core of claim 1, wherein the adhesive coating is heat resistant up to at least 400° C.

18. The method of claim 10,
wherein the adhesive-coated outer peripheral area comprises four segments of the adhesive-coated outer peripheral area extending along four sides of the major face and each having an average or maximum width, measured perpendicularly to a line along which the side extends, wherein a ratio determined as the maximum width of the segments of the adhesive-coated outer peripheral area that extend along the length direction divided by the sheet width is less than 0.15, and/or wherein a ratio determined as the maximum width of the segments of the adhesive-coated outer peripheral area that extend along the width direction divided by the sheet length is less than 0.15.

19. The method of claim 10, wherein the adhesive coating is heat resistant up to at least 300° C.

20. The method of claim 10, wherein the adhesive coating is heat resistant up to at least 400° C.
